(19) United States
(12) Patent Application Publication
(10) Pub. No.: US 2026/0312398 A1
(43) Pub. Date: Oct. 8, 2026

(54) SAFETY MECHANISM IN A POWER RECEIVER

(71) Applicant: DOLBY INTELLECTUAL PROPERTY LICENSING, LLC, San Francisco, CA (US)

(72) Inventors: Jayanti GANESH, Bangalore (IN); Viswanathan KANAKASABAI, Bangalore (IN); Subbarao TATIKONDA, Bangalore (IN); Suma Memana NARAYANA BHAT, Bangalore (IN)

(73) Assignee: DOLBY INTELLECTUAL PROPERTY LICENSING, LLC, San Francisco, CA (US)

(21) Appl. No.: 19/485,102

(22) PCT Filed: May 21, 2024
(86) PCT No.: PCT/US2024/030369

§ 371 Date: Nov. 17, 2025

(30) Foreign Application Priority Data
May 22, 2023 (IN) 202311035623

(51) Int. Cl. H02H 7/00; H02J 50/10

(52) U.S. Cl. CPC H02H 7/008; H02J 50/10

(57) ABSTRACT

This disclosure provides systems, methods and apparatuses for a safety mechanism and related operations in an appliance having a Power Receiver (PRx) of a wireless power system. The safety mechanism includes a fuse configured to fail (referred to as “blowing the fuse”) when a fault condition (such as overvoltage or overcurrent) occurs. The fuse is designed to blow, thereby interrupting the power supply to the appliance. By blowing the fuse, the excess voltage or current is effectively disconnected in the appliance, preventing damage to the internal circuitry and other components of the appliance. The safety mechanism might include a fuse blowing switch controlled by a PRx controller and configured to cause the fuse to intentionally blow when the PRx controller detects a fault condition. An optional capacitance element might increase current through the fuse to enhance the protective capability of the fuse.

### TECHNICAL FIELD

This disclosure relates generally to wireless power and some aspects relate to a safety mechanism and related operations in a Power Receiver of a wireless power system.

### DESCRIPTION OF RELATED TECHNOLOGY

A wireless power system includes a Power Transmitter (PTx) and a Power Receiver (PRx). Inductive coupling can enable wireless power transfer between a primary coil of the Power Transmitter and a secondary coil of the Power Receiver. The primary coil of the Power Transmitter produces an electromagnetic field during a power state of the wireless power system. The electromagnetic field induces a voltage in the secondary coil of the Power Receiver when the secondary coil is present in the electromagnetic field. The Power Receiver can use the induced voltage (either directly or via a rectifier) to power a load. Example loads might include a motor, a heating element, electronics, or a power storage device, among other examples. In an example kitchen environment. a magnetic power source (such as a kitchen hob) might include one or more Power Transmitters. An appliance (such as a cordless kitchen appliance) might include a Power Receiver as well as the load. The appliance can be placed on a Power Transmitter such that the Power Receiver of the appliance can receive wireless power from the magnetic power source.

Some appliances are equipped with safety features to mitigate potential damage caused by a faulty Power Transmitter, an unexpected power surge, unintended powering, or a component failure in the Power Transmitter or the Power Receiver. A safety feature might mitigate potential damage to the Power Receiver, other components of an appliance that contains the Power Receiver, or the operating environment of the appliance. An example safety feature is a disconnect switch configured to disconnect the load from the secondary coil. For example, the disconnect switch can be connected in series between one terminal of the secondary coil and another component (such as a rectifier of the Power Receiver or a load of the appliance). The disconnect switch is suitable to provide safety for some situations, such as before a power state. In an emergency condition, the Power Receiver can open the disconnect switch to disable power reception in the event of an overvoltage or overcurrent condition. However, it has been discovered that opening the power reception circuit during a power state can cause high voltages to become temporarily induced across the disconnect switch. The high voltages or a failure of the disconnect switch can result in damage to the disconnect switch, the Power Receiver, the appliance, or the operating environment of the appliance.

### BRIEF SUMMARY

The systems, methods, and apparatuses of this disclosure each have several innovative aspects, no single one of which is solely responsible for the desirable attributes disclosed herein.

One aspect of this disclosure can be implemented in a Power Receiver of a wireless power system. The Power Receiver includes a secondary coil configured to receive wireless power from a primary coil of a Power Transmitter. The Power Receiver includes a fuse configured to disconnect the secondary coil from a power reception circuit or a load associated with the Power Receiver.

Another aspect of this disclosure can be implemented in a method of a Power Receiver (PRx) controller. The method includes obtaining a voltage or current measurement at a power reception circuit of the Power Receiver or at a load associated with the Power Receiver. The method includes causing a fuse to blow when the voltage or current measurement exceeds a threshold.

Another aspect of this disclosure can be implemented in a method of a Power Receiver. The method includes monitoring a voltage or current measurement at a power reception circuit of the Power Receiver or at a load associated with the Power Receiver during a power state. The method includes sending a switch control signal to a fuse blowing switch when the voltage or current measurement exceeds a threshold. The switch control signal causes the fuse blowing switch to short circuit a circuit that includes a replaceable safety fuse and a secondary coil of the Power Receiver.

Details of one or more implementations of the subject matter described in this disclosure are set forth in the accompanying drawings and the description below. Other features, aspects, and advantages will become apparent from the description, the drawings, and the claims.

### BRIEF DESCRIPTION OF THE SEVERAL VIEWS OF THE DRAWINGS

Like reference numbers and designations in the various drawings indicate like elements. Note that the relative dimensions of the figures may not be drawn to scale.

FIG. 1 illustrates an example wireless power system.

FIG. 2 illustrates an example Power Receiver with a fuse to protect the appliance from a fault condition.

FIG. 3 illustrates an example Power Receiver with a safety mechanism that includes a fuse and a fuse blowing switch.

FIG. 4 illustrates an example Power Receiver with a safety mechanism that includes a fuse, a fuse blowing switch, and a capacitance element.

FIG. 5 illustrates an example Power Receiver with a safety mechanism in which a fuse blowing switch is positioned after a series capacitor of the Power Receiver.

FIG. 6 illustrates a flow chart with example operations of a Power Receiver.

FIG. 7 illustrates another flow chart with example operations of a Power Receiver that includes a fuse blowing switch.

FIG. 8 illustrates a block diagram of an example apparatus for use in a wireless power system.

### DETAILED DESCRIPTION

The following description is directed to certain implementations for the purpose of describing innovative aspects of this disclosure. However, a person having ordinary skill in the art will readily recognize that the teachings herein can be applied in a multitude of different ways. The described implementations can be implemented in any means, apparatus, system, or method for transmitting or receiving wireless power.

A wireless power system includes a Power Transmitter (PTx) and a Power Receiver (PRx). A Power Transmitter also may be referred to as a wireless power transmission apparatus. A Power Receiver also may be referred to as a wireless power reception apparatus. Some examples of this disclosure are based on a kitchen environment. For example, the Power Transmitter might be part of a magnetic power source such as a hob, a countertop, or range. In some implementations, the Power Transmitter may include a surface-mounted primary coil, an integrated primary coil, a countertop-mounted primary coil or a primary coil that is embedded or manufactured in a surface on which a Power Receiver can be placed. A Power Receiver includes a secondary coil configured to wirelessly receive power via inductive coupling with the primary coil of the Power Transmitter. The Power Receiver might be part of a cordless appliance such as a cordless blender, kettle, toaster, or cooking vessel, among other examples. Although the examples of this disclosure refer to a wireless power system in a kitchen environment, the disclosed techniques can be used with other types of wireless power systems or in other types of environments.

The amount of power transferred from a Power Transmitter to a Power Receiver is normally managed by power control mechanisms, such as communication from the Power Receiver to the Power Transmitter. Nonetheless, the power control mechanisms might fail or inadequately react to changes in the wireless power system. Therefore, it is desirable to protect an appliance from overvoltage, overcurrent, or unintended powering. Some appliances are equipped with a disconnect switch. In some implementations, the disconnect switch is connected in series with a terminal of the secondary coil. The disconnect switch is typically opened or closed based on the current state of the wireless power system. For example, the disconnect switch is closed during a power state to enable power reception via the secondary coil. Conversely, the disconnect switch is open during pre-power power states to prevent power reception via the secondary coil. In an emergency fault condition (such as overvoltage or overcurrent), the Power Receiver might open the disconnect switch to mitigate potential damage to the Power Receiver or other components of the appliance. However, opening the disconnect switch during the power state can result in high voltages at the disconnect switch and could result in damage to the disconnect switch, other components of the appliance, or even the operating environment of the appliance. In some instances, when the disconnect switch or the appliance is damaged, the appliance might require costly or time-consuming repairs to restore functionality.

This disclosure provides systems, methods and apparatuses for a safety mechanism and related operations in a Power Receiver of a wireless power system. The safety mechanism includes a fuse configured to fail (referred to as “blowing the fuse”) when a fault condition occurs. The fuse can be referred to as a safety fuse, protective fuse, fuse wire, fuse element, breaker, safety trip, overcurrent protector, or other similar terms. In some implementations, the fuse can be an inexpensive, replaceable part intended for relatively easy end-user servicing of the appliance. The fuse is designed to blow, thereby interrupting the power supply to the appliance. By blowing the fuse, the excess voltage or current is effectively redirected away from the appliance, preventing damage to the internal circuitry and other components of the appliance.

In addition to the fuse, the safety mechanism can include a switch (which may be referred to as a “fuse blowing switch”) configured to intentionally cause the fuse to blow. A PRx controller can operate the fuse blowing switch to force the fuse to fail when the PRx controller detects a fault condition, such as an overvoltage or overvoltage condition, sudden voltage spikes, abnormal current levels, abnormal power from the Power Transmitter. or any combination thereof. Once a fault condition is detected, the PRx controller operates the fuse blowing switch to ensure that a high enough current flows through the fuse, causing the fuse to melt and sever the series electrical circuit.

In some aspects, the safety mechanism further includes a capacitance clement configured to improve the likelihood that the fuse will blow. For example, the capacitance element can introduce impedance to a circuit that includes the fuse. The impedance caused by the capacitance element can cancel some impedance associated with the secondary coil such that the current through the fuse is increased. In some implementations, the capacitance element can be connected in series with the fuse blowing switch so that the capacitance element is introduced to the power reception circuit when the PRx controller closes the fuse blowing switch. Alternatively, or additionally, the capacitance element can be connected in series with the fuse and the fuse blowing switch can be a shunt switch configured to close a circuit that includes the secondary coil, the fuse, and the capacitance element.

In some implementations, after the fuse is blown, a user interface of the appliance can indicate the blown state of the fuse. The power for the user interface can be harvested wirelessly from the wireless communication channel created by the Power Transmitter on which the appliance is placed.

Particular implementations of the subject matter described in this disclosure can be implemented to realize one or more of the following potential advantages. By incorporating a replaceable safety fuse, the risk of damage to the appliance due to voltage surges or faulty transmitters is significantly reduced. Moreover, the controlled blowing of the fuse ensures that the excess energy is safely diverted, thereby minimizing the potential for damage to both the cordless appliance and the disconnect switch itself. By integrating a replaceable safety fuse in series with the secondary coil and employing a fuse blowing switch to cause the fuse to blow when emergencies occur, the disclosed safety mechanism enhances the overall safety and reliability of cordless appliances, thereby offering a valuable improvement to a wireless power system.

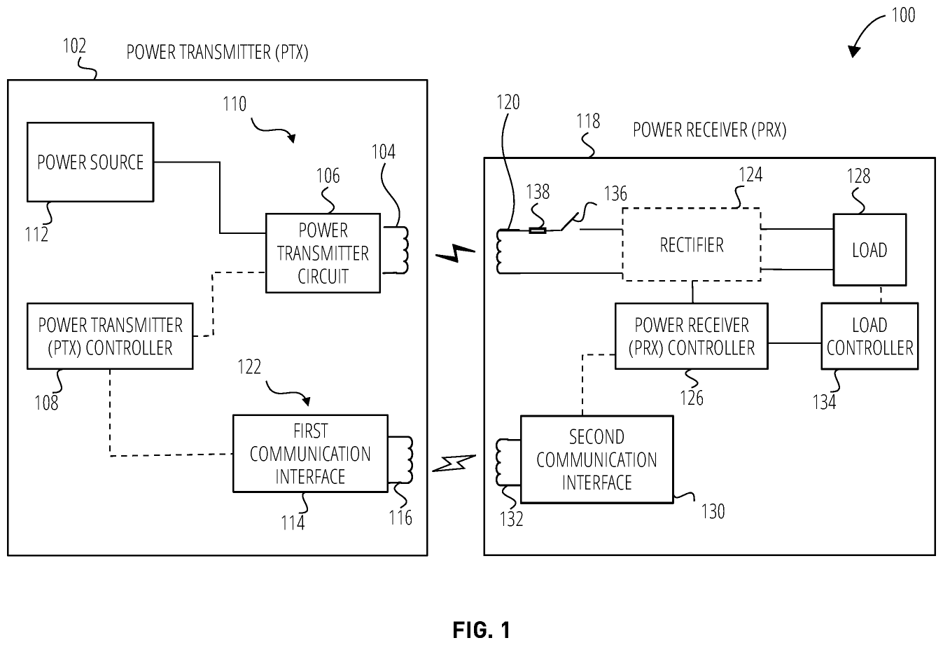

FIG. 1 illustrates an example wireless power system 100. The example wireless power system 100 includes a Power Transmitter 102 and a Power Receiver 118. In FIG. 1, dashed lines represent communications to distinguish from the solid lines that represent electrical circuit lines. The Power Transmitter 102 includes a primary coil 104 and a PTx controller 108. The primary coil 104 may be associated with a power transmitter circuit 106 (sometimes also referred to as a power signal generator, or a driver circuit, or a driver). The primary coil 104 may be a wire coil which transmits wireless power (which also may be referred to as wireless energy). The primary coil 104 may transmit wireless energy using an inductive or a resonant magnetic field. The power transmitter circuit 106 may include components (not shown) to prepare the wireless power. For example, the power transmitter circuit 106 may include one or more switches, drivers, series capacitors, rectifiers, inverters, or other components. In some implementations, the power transmitter circuit 106, PTx controller 108 and other components (not shown) may be collectively referred to as a power transmitter unit 110. Some or all of the power transmitter unit 110 may be embodied as an integrated circuit (IC) that implements features of this disclosure. The PTx controller 108 may be implemented as a microcontroller, dedicated processor, integrated circuit, application specific integrated circuit (ASIC) or any other suitable electronic device.

A power source 112 provides power to the power transmitter unit 110. In some implementations, the power source 112 may convert alternating current (AC) power to direct current (DC) power. For example, the power source 112 may include a converter that receives an AC power from an external power supply and converts the AC power to a DC power used by the power transmitter circuit 106. Alternatively, or additionally, a component (such as an inverter) of the power transmitter circuit 106 may convert the DC power to the AC power. The power source 112 may be integrated as part of the Power Transmitter 102 or may be external to the Power Transmitter 102. In some implementations, the Power Transmitter 102 causes the power source 112 to regulate the DC output voltage of the power source 112. For example, the PTx controller 108 can set DC voltage of the power source 112 based on information (such as a value indicating a requested power) received from the Power Receiver 118. The Power Transmitter 102 can receive power configuration information from the Power Receiver 118 and use the information to set a parameter (such as the DC output voltage of the power source 112) The Power Transmitter 102 can receive the power configuration information during various operating states, such as the discovery state or power state. In some implementations, the Power Transmitter 102 includes a DC-DC converter (not shown) between the power source 112 and the Power Transmitter circuit 106 to control the variable DC output voltage.

The PTx controller 108 is connected to a first communication interface 114. The first communication interface 114 is connected to a first communication coil 116. In some implementations, the first communication interface 114 and the first communication coil 116 may be collectively referred to as the first communication unit 122. In some implementations, the first communication unit 122 may support short-range radio frequency communication, such as Near-Field Communication (NFC) or Bluetooth (BT). NFC is a technology by which data transfer occurs on a carrier frequency of 13.56 Megahertz (MHz). The first communication unit 122 also may support any suitable communication protocol. The first communication unit 122 may contain modulation and demodulation circuits to wirelessly communicate via the first communication coil 116. Alternatively, or additionally, the PTx controller 108 may use frequency, amplitude, current, or voltage modulation of a wireless power signal to communicate via an in-band communication link (not shown) that includes the primary coil 104.

The Power Receiver 118 may include a secondary coil 120, a rectifier 124, a PRx controller 126, a second communication interface 130, a load controller 134, a load 128, and a memory (not shown). In some implementations, the load 128 can include a driver (not shown) for controlling at least one parameter such as charging current, speed, or torque of the load. In some implementations, the rectifier 124 may be omitted such as when the voltage induced in the secondary coil 120 can directly power the load 128. Although not shown, a load capacitance can be used after the rectifier 124 to filter a high frequency component of the rectifier voltage. Although shown as different components, some components may be packaged or implemented in the same hardware. For example, in some implementations. the PRx controller 126 and the load controller 134 may be implemented as a single controller. The PRx controller 126, the load controller 134, or any combination thereof, may be implemented as a microcontroller, dedicated processor, integrated circuit, application specific integrated circuit (ASIC) or any other suitable electronic device.

The PTx controller 108 may detect the presence or proximity of a Power Receiver 118. This detection may happen during a periodic pinging process of the first communication interface 114. During the pinging process, the first communication interface 114 also may supply power to the second communication interface 130 when the Power Receiver 118 is in proximity to the Power Transmitter 102. The second communication interface 130 may “wake up” and power-up the PRx controller 126 and may send a reply signal back to the first communication interface 114. Prior to power transfer, a handshaking process may take place during which the PTx controller 108 may receive identification and configuration data, among other information, from the Power Receiver 118. The PTx controller 108 may control characteristics of wireless power it provides to the Power Receiver 118 based on the configuration data.

A PRx controller 126 may be operationally coupled to the rectifier 124 and the second communication interface 130. The second communication interface 130 may contain modulation and demodulation circuits to wirelessly communicate via the second communication coil 132. Thus, the PRx controller 126 may wirelessly communicate feedback information to the PTx controller 108 via the second communication interface 130 to the first communication interface 114 using short-range radio frequency communication, such as NFC. Alternatively, or additionally, the PRx controller 126 may use load modulation to communicate via an in-band communication link (not shown) that includes the secondary coil 120.

A load controller 134 may be operationally coupled to the load 128 and the second communication interface 130. The load controller 134 may detect changes to load states such as change in charging currents in a battery charging application. The load controller 134 also may determine a load voltage reference. The load controller 134 also may send load voltage references, load current, and any other suitable information to the PRx controller 126 or the second communication interface 130 for communication to the Power Transmitter 102. The PRx controller 126 may additionally determine and provide feedback information indicating a measured load voltage available to the load 128. In some feedback messages, the feedback information may include a reference voltage indicating a required voltage for the load 128, an error in the output voltage of the load 128, or the required power for the load. Although the PRx controller 126 and load controller 134 are shown separately, they may be included in the same component of the Power Receiver 118.

The Power Transmitter 102 and the Power Receiver 118 might operate according to wireless power specification. The wireless power specification might include a state diagram that describes the operating states in which the wireless power system may operate. There can be four operating states associated with the wireless power system: a standby state (sometimes also referred to as a ping phase), a discovery state (sometimes referred to as an identification phase), a connected state, and a power state (sometimes referred to as a power transfer phase). The wireless power system typically begins in the standby state until the Power Transmitter detects a Power Receiver. In the discovery state, the Power Transmitter establishes communication and receives the first identification information of the Power Receiver and its static configuration data. In the connected state and the power state, the Power Transmitter and Power Receiver exchange information to agree and adjust parameters related to wireless power transfer. The system can move to a reinitialization state as needed to reinitialize or return to the standby state when communication, powering, or other activities are no longer taking place. Each of the operating states are briefly described herein for reference.

In the standby state, the Power Transmitter tries to establish communications with a Power Receiver. The Power Receiver may be just placed on the interface surface or may not be present during this operating state. The Power Transmitter may attempt to communicate or detect the presence of the Power Receiver. For example, the Power Transmitter may use an analog ping, out-of-band communication (such as NFC), a digital ping, or any combination thereof, to determine that a compatible Power Receiver is present. Once the wireless power system determines that a Power Receiver is present (such as by confirming NFC communication), the wireless power system may transition to the discovery state 204.

In the discovery state, the Power Receiver may establish communication with the Power Transmitter and send static configuration information (such as identification and configuration information) to the Power Transmitter. For example, the Power Transmitter may retrieve static configuration information from the Power Receiver via the NFC communication. The Power Transmitter and the Power Receiver may use this information to verify that they both use compatible versions of a technical specification or protocol for wireless power transfer. The Power Transmitter and Power Receiver may communicate basic settings or communicate regarding their respective capabilities. From the discovery state 204, the wireless power system may transition to the connected state.

In the connected state, the Power Transmitter and the Power Receiver may exchange further communications to negotiate the parameters that govern the power state. For example, a power negotiation can occur during the connected state. After negotiating the parameters, the Power Transmitter may be prepared to transfer wireless power and the Power Receiver may be prepared to receive the wireless power. However, the Power Transmitter may wait for a request or command from the Power Receiver before transitioning to the power state. This may be useful, for example, when a cordless appliance (such as a blender, toaster, mixer, or microwave, among other examples) is configured for use pending a user interaction. The user may initiate the power state a user interface (such as an activation switch) of the Power Receiver, which in turn communicates to the Power Transmitter to transition to the power state.

Some appliances are equipped with a safety feature, such as a disconnect switch 136, that are operated in conjunction with the operating states. For example, the disconnect switch 136 might be maintained in an open position to prevent the flow of current to the load 128 when the Power Receiver 118 is in the pre-power states (the standby state, the discovery state, and the connected state). Before transitioning to the power state, the PRx controller 126 might cause the disconnect switch 136 to move to a closed position to enable the flow of current to the load 128. In an emergency condition (such as excessive voltage or current), the PRx controller 126 might open the disconnect switch 136 to prevent damage to the load 128 or other components of the Power Receiver 118. However, opening the disconnect switch 136 during the power state can potentially damage the disconnect switch 136 due to excessive voltages caused by removing the load 128. Furthermore, the disconnect switch 136 might be implemented as a relay switch which is less optimal for interrupting current or which might be too slow to prevent damage in a wireless power system using high voltage or high frequency wireless power signals.

In accordance with this disclosure, the Power Receiver 118 includes a fuse 138. The fuse 138 is configured to blow when current through the secondary coil 120 exceeds the rating of the fuse 138. The fuse 138 might include an element that connects each terminal of the fuse 138. The element is configured to melt at a predetermined current or voltage level. When the element melts, the connection between the terminals of the fuse 138 is severed, thus opening the circuit to interrupt the electrical path through the fuse 138. A rating of the fuse 138 refers to the current level at which the element of the fuse 138 melts and a voltage level which can be blocked by the fuse 138 after the element melts. The rating of fuse 138 might be above a nominal current expected for the Power Receiver 118 and lower than a safety threshold selected to prevent damage to the power reception circuit or the load 128.

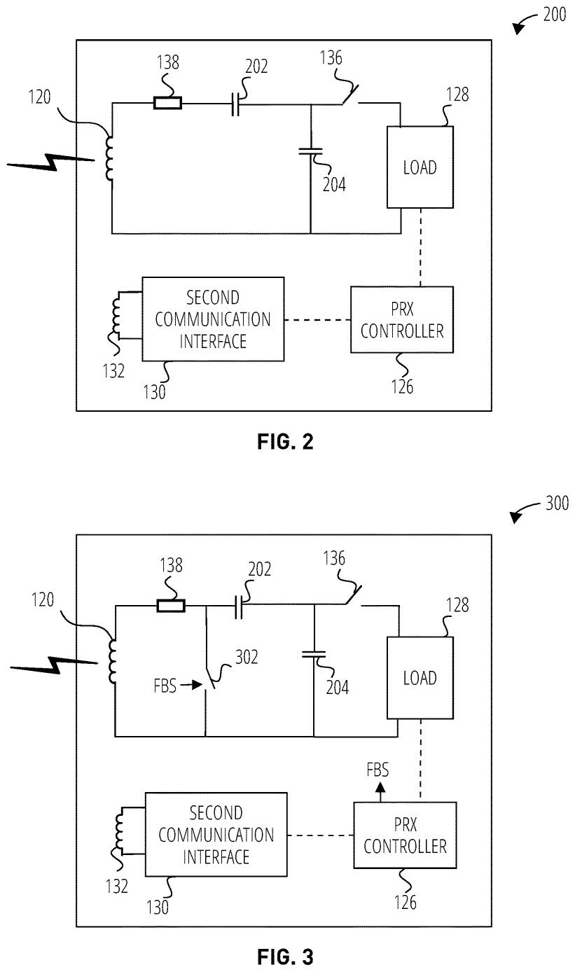

FIG. 2 illustrates an example Power Receiver 200 with a fuse 138 to protect an appliance from a fault condition. The example Power Receiver 200 may be an example of the Power Receiver 118 described with reference to FIG. 1. The Power Receiver 200 may be included in an appliance. The Power Receiver 200 might include a load 128 or the load 128 may be component of the appliance that also includes the Power Receiver 200.

The Power Receiver 200 includes a secondary coil 120, a second communication coil 132, a second communication interface 130, and a PRx controller 126 as described with reference to FIG. 1. In some implementations, the Power Receiver 200 may or may not include a rectifier (not shown in FIG. 2). FIG. 2 also shows a series capacitor 202 that may be coupled to one or more terminals of the secondary coil 120. The example Power Receiver 200 includes a disconnect switch 136 connected in a series between one of the terminals of the secondary coil 120 and the load 128. The disconnect switch 136 may be connected before or after the series capacitor 202 when the series capacitor 202 is present on that terminal. Although the disconnect switch 136 is shown as being connected in series, other configurations are possible. For example, instead of a single series switch (such as the disconnect switch 136 shown in FIG. 2), the Power Receiver 200 may include first and second disconnect switches (not shown) connected in series between both terminals of the secondary coil 120. A first disconnect switch (not shown) may be connected in series to a first terminal of the secondary coil 120 while a second disconnect switch (not shown) may be connected in series to a second terminal of the secondary coil 120. The first and second disconnect switches may be collectively referred to as a disconnect switch.

As described herein, the disconnect switch 136 may be ineffective, or less effective, in mitigating the risks of damaged caused by an overcurrent or overvoltage condition. An overvoltage or overvoltage condition can occur as a result of a faulty Power Transmitter. For example, the Power Transmitter may continue sending power beyond a time limit or power contract, or might experience a controller or communication fault that causes the Power Transmitter to transmit excessive power. The fuse 138 is configured to blow when the fault condition occurs to mitigate damage caused by the fault condition. When the fuse 138 blows, an element of the fuse 138 melts, causing the electrical path from the secondary coil 120 to the load 128 (as well as potentially the series capacitor 202 or the disconnect switch 136) to become severed.

The type of the fuse 138 might be based on empirical testing to select a fuse that will blow before damage is caused to the Power Receiver 200. For example, the fuse 138 might be selected such that the fuse is long enough to prevent restrike across open terminals of the fuse when the fuse blows. The term “long enough” can refer to the distance between the end terminals of the fuse or might refer to the length of the element in the fuse 138. Restrike refers to an electrical discharge or arc in which a voltage can traverse a melted element or open-air gap between the terminals of a blown fuse. Additionally, or alternatively, the rating of the switch should be high enough to block a maximum induced voltage in the secondary coil to prevent restrike across open terminals of the fuse.

FIG. 3 illustrates an example Power Receiver 300 with a safety mechanism that includes a fuse 138 and a fuse blowing switch 302. The example Power Receiver 300 may be an example of the Power Receiver 118 described with reference to FIG. 1. As described with reference to FIG. 2, the Power Receiver 300 may be included in an appliance with a load 128, and the Power Receiver 300 includes a secondary coil 120, a second communication coil 132, a second communication interface 130, and a PRx controller 126 as described herein. Different from FIG. 2, the Power Receiver 300 of FIG. 3 includes a fuse blowing switch 302. In some implementations, the fuse blowing switch 302 is a semiconductor switch or a mechanical relay. The fuse blowing switch 302 can redirect most current away from other components of the Power Receiver 300 and maintain or increase the current in a circuit that includes the secondary coil 120 and the fuse 138. The current is increased because the secondary coil 120 with the induced voltage is shorted with a low impedance offered by the fuse 138 and the fuse blowing switch 302. When the fuse blowing switch 302 is in a closed position, the more current might pass through the fuse 138 than would otherwise be at the fuse 138 if the fuse blowing switch 302 is in an open position. The rating (such as current rating of I²t) of the fuse blowing switch 302 is higher than the rating of the fuse 138.

The PRx controller 126 might operate the fuse blowing switch 302 using a switch control signal (labeled as fuse blowing switch (FBS) signal). In some implementations, the FBS signal might be a pin line or other connection from the PRx controller 126 to the fuse blowing switch 302. When the PRx controller 126 detects a fault condition, the PRx controller 126 can send the FBS signal to cause the fuse blowing switch 302 to close, thereby improving the likelihood that the fuse 138 will blow. In some implementations, the PRx controller 126 detects the fault condition when a current or voltage measurement exceeds a safety threshold. The PRx controller 126 might obtain a current or voltage measurement from a sensor (not shown) at any of the components of the power reception circuit, such as a sensor at the secondary coil 120. the series capacitor 202, the disconnect switch 136, or the load 128.

There may be other conditions under which the PRx controller 126 intentionally closes the fuse blowing switch 302 to cause the fuse 138 to blow. For example, the PRx controller 126 might intentionally close the fuse blowing switch 302 for any condition in which the PRx controller 126 deems that blowing the fuse 138 is warranted to protect the appliance from damage from Power Transmitter.

Some implementations of the fuse blowing switch 302 are designed as a shunt switch (as shown in FIG. 3). A shunt switch connects two terminals of the secondary coil 120 when the shunt switch is closed. A potential technical advantage of the fuse blowing switch 302 being a shunt switch is that the shunt switch can be isolated out of the power reception circuit when the fuse blowing switch 302 is open. Nonetheless, other configurations of the fuse blowing switch 302 are possible. For example, a fuse blowing switch might be configured as a bypass switch connected in parallel with the fuse 138. In such a configuration, the fuse blowing switch would remain closed during normal operation so that current bypasses the fuse. When the PRx controller 126 causes the bypass switch to open, thereby causing current to traverse and blow the fuse.

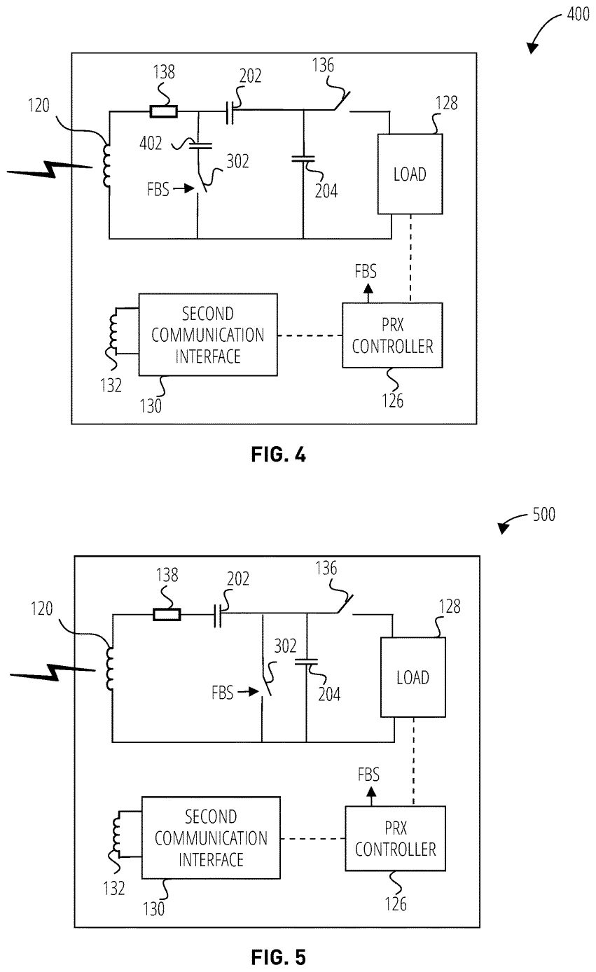

FIG. 4 illustrates an example Power Receiver 400 with a safety mechanism that includes a fuse 138, a fuse blowing switch 302, and a capacitance element 402. The Power Receiver 400 has similar parts as those described with like reference numbers with reference to FIG. 3. Different from FIG. 3, the Power Receiver 400 of FIG. 4 includes a capacitance element 402. In the example of FIG. 4, the capacitance element 402 is positioned in series with the fuse blowing switch 302, and the fuse blowing switch 302 is implemented as a shunt switch. A potential technical advantage of the capacitance element 402 in this configuration is that the impedance of the capacitance element 402 might match or cancel some of the impedance of the secondary coil 120. As a result, more current will traverse through the fuse 138. Thus, the capacitance element 402 increases the likelihood that the fuse 138 will blow when the fuse blowing switch 302 is closed.

FIG. 5 illustrates an example Power Receiver 500 with a safety mechanism in which a fuse blowing switch 302 is positioned after a series capacitor 202 of the Power Receiver. The Power Receiver 500 has similar parts as those described with like reference numbers with reference to FIG. 3 and FIG. 4. Different from FIG. 4, the Power Receiver 500 of FIG. 5 omits the capacitance element and instead makes use of the series capacitor 202. The fuse blowing switch 302 is implemented as a shunt switch and is connected to legs of the secondary coil 120 such that the series capacitor 202 is included in the circuit formed with the secondary coil 120 and the fuse 138 when the fuse blowing switch 302 is closed. A potential technical advantage of the design in FIG. S is that the safety mechanism incorporates the series capacitor 202, which might already be existing in the Power Receiver 500. Because the parallel capacitor 204 is small, shorting the capacitor using the fuse blowing switch 302 causes the parallel capacitor 204 to discharge and the discharged current flows through the fuse blowing switch 302. Thus, the fuse blowing switch 302 should have a rating that is higher than the fuse current, the current due to discharge of parallel capacitor 204 and any load current that may flow through the shorted path of the fuse blowing switch 302.

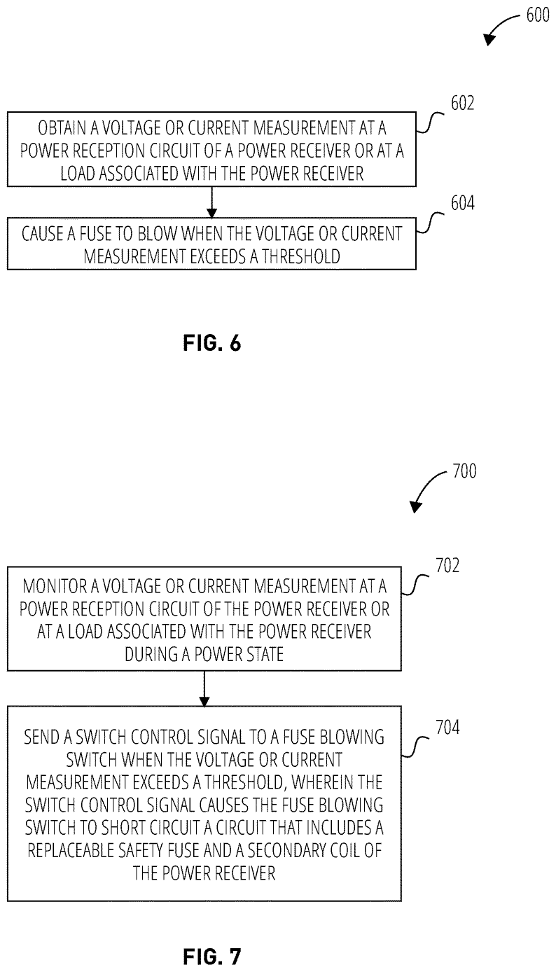

FIG. 6 illustrates a flow chart with example operations 600 of a Power Receiver. For example, the operations 600 might be performed by any of the Power Receivers 118, 200, 300, 400 or 500 described with reference to FIG. 1, FIG. 2, FIG. 3. FIG. 4. or FIG. 5. respectively. In block 602, the Power Receiver obtains a voltage or current measurement at a power reception circuit a Power Receiver or at a load associated with the Power Receiver. In block 604, Power Receiver causes a fuse to blow when the voltage or current measurement exceeds a threshold.

FIG. 7 illustrates another flow chart with example operations 700 of a Power Receiver that includes a fuse blowing switch. For example, the operations 700 might be performed by any of the Power Receivers 300, 400 or 500 described with reference to FIG. 3, FIG. 4, or FIG. 5, respectively. In block 702, the Power Receiver monitors a voltage or current measurement at a power reception circuit of the Power Receiver or at a load associated with the Power Receiver during a power state. In block 704, the Power Receiver sends a switch control signal to a fuse blowing switch when the voltage or current measurement exceeds a threshold. The switch control signal causes the fuse blowing switch to short circuit a circuit that includes a replaceable safety fuse and a secondary coil of the Power Receiver.

The threshold described with reference to blowing a fuse (such as the threshold described with reference to FIG. 3, FIG. 6 or FIG. 7) might be referred to as a safety threshold. In some implementations, the safety threshold might be a current or voltage value. For example, the safety threshold might be twenty percent (20%), thirty percent (30%), fifty percent (50%), or a hundred percent (100%), among other examples, higher than a nominal current or voltage for the wireless power system. In some implementations, the safety threshold might be dynamically configured by a user configurable setting, a manufacturer setting, or a controller-determined setting. The safety threshold might be based on a power rating for the appliance. In some implementations, the safety threshold might be adjusted up or down relative to the current amount of power requested, a power measurement of the Power Receiver, or a power limit of the Power Transmitter.

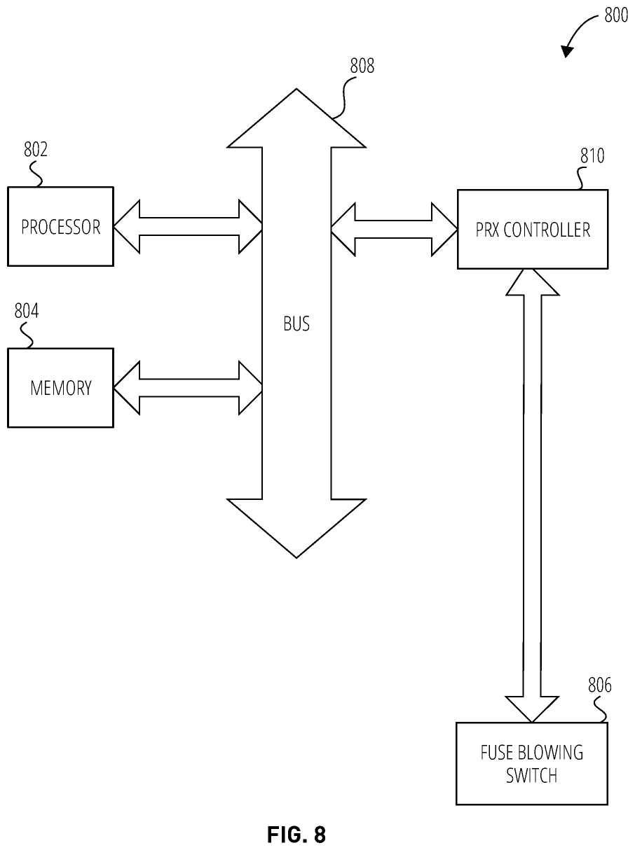

FIG. 8 illustrates a block diagram of an example apparatus for use in a wireless power system. In some implementations, the apparatus 800 may be a wireless power apparatus (such as any of the Power Receivers 118. 200, 300, 400 or 500 described with reference to FIG. 1, FIG. 2, FIG. 3, FIG. 4, or FIG. 5, respectively. The apparatus 800 can include a processor 802 (possibly including multiple processors, multiple cores, multiple nodes, or implementing multi-threading, among other examples). The apparatus 800 also can include a memory 804. The memory 804 may be system memory or any one or more of the possible realizations of computer-readable media described herein. The apparatus 800 also can include a bus 808 (such as PCI, ISA, PCI-Express, HyperTransport®, InfiniBand®, NuBus,® AHB, AXI, etc.).

The apparatus 800 may include one or more PRx controllers 810. In some implementations, the PRx controller 810 can be distributed within the processor 802, the memory 804, and the bus 808. The PRx controller 810 may perform some or all of the operations described herein. For example, the PRx controller 810 may implement the operations described with reference to any one of FIG. 1 through FIG. 7, or any combination thereof.

The memory 804 can include computer instructions executable by the processor 802 to implement the functionality of the implementations described herein. Any one of these functionalities may be partially (or entirely) implemented in hardware or on the processor 802. For example, the functionality may be implemented with an application specific integrated circuit, in logic implemented in the processor 802, in a co-processor on a peripheral device or card, etc. Further, realizations may include fewer or additional components not illustrated in FIG. 8. The processor 802, the memory 804, and the PRx controller 810 may be coupled to the bus 808. Although illustrated as being coupled to the PRx controller 810, the memory 804 may be coupled to the processor 802.

In some implementations, the apparatus 800 includes a fuse blowing switch 806. The fuse blowing switch 806 might be configured to short circuit the fuse with a power transfer coil (such as a secondary coil (not shown)). The PRx controller 810 might operate the fuse blowing switch 806 to implement the operations described with reference to any one of FIG. 1 through FIG. 7, or any combination thereof.

FIG. 1 through FIG. 8 and the operations described herein are examples meant to aid in understanding example implementations and should not be used to limit the potential implementations or limit the scope of the claims. Some implementations may perform additional operations, fewer operations, operations in parallel or in a different order, and some operations differently.

The foregoing disclosure provides illustration and description but is not intended to be exhaustive or to limit the aspects to the precise form disclosed. Modifications and variations may be made in consideration of the above disclosure or may be acquired from practice of the aspects. While the aspects of the disclosure have been described in terms of various examples, any combination of aspects from any of the examples is also within the scope of the disclosure. The examples in this disclosure are provided for pedagogical purposes. Alternatively, or in addition to the other examples described herein, examples include any combination of the following implementation options (identified as clauses for reference).

### CLAUSES

Clause 1. A Power Receiver, including: a secondary coil configured to receive wireless power from a primary coil of a Power Transmitter; and a fuse configured to disconnect the secondary coil from a power reception circuit or a load associated with the Power Receiver.

Clause 2. The Power Receiver of clause 1, further including: a capacitance element configured to match or cancel a portion of the impedance of the secondary coil.

Clause 3. The Power Receiver of clause 2, where the capacitance element is selectively enabled based on an overvoltage or overcurrent condition of the Power Receiver.

Clause 4. The Power Receiver of any one of clauses 1 to 3, further including: a fuse blowing switch configured to short circuit the secondary coil and fuse.

Clause 5. The Power Receiver of clause 4, further including: a controller configured to operate the fuse blowing switch, where the controller causes the fuse blowing switch to close based on a determination that a voltage or a current of the power reception circuit or the load is above a threshold.

Clause 6. The Power Receiver of clause 5, further including: a sensor configured to detect the voltage or the current of the power reception circuit or the load during a power state, where the controller is configured to: monitor the voltage or the current during the power state, and close the fuse blowing switch when the voltage or the current exceeds the threshold during the power state.

Clause 7. The Power Receiver of any one of clauses 4 to 6, where the fuse has a lower rating than the fuse blowing switch.

Clause 8. The Power Receiver of any one of clauses 4 to 7, where the fuse is connected in series on a first leg of the secondary coil, and where the fuse blowing switch is a shunt switch that connects a second leg of the secondary coil to the fuse such that the shunt switch closes a circuit that includes the secondary coil and the fuse.

Clause 9. The Power Receiver of clause 8, where the capacitance element is connected in series with the shunt switch.

Clause 10. The Power Receiver of any one of clauses 4 to 9, where the fuse blowing switch is a semiconductor switch or a mechanical relay.

Clause 11. The Power Receiver of any one of claims 1 to 10, where the fuse is rated to block a maximum induced voltage in the secondary coil to prevent restrike across open terminals of the fuse.

Clause 12. The Power Receiver of any one of clauses 1 to 11, where the fuse has a current rating that is at least twenty percent (20%) higher than a nominal current of the Power Receiver.

Clause 13. The Power Receiver of any one of clauses 1 to 12, where the fuse is an end-user replaceable part of the Power Receiver.

Clause 14. A method of a Power Receiver (PRx) controller, including: obtaining a voltage or current measurement at a power reception circuit of the Power Receiver or at a load associated with the Power Receiver; and causing a fuse to blow when the voltage or current measurement exceeds a threshold.

Clause 15. The method of clause 14, where causing the fuse to blow includes: sending a switch control signal to a fuse blowing switch to cause the fuse blowing switch to short circuit a circuit that includes the fuse and a secondary coil of the Power Receiver.

Clause 16. The method of clause 14 or 15, further including: monitoring the voltage or current measurement during a power state; attempting to control power based on the voltage or current measurement by communicating with a Power Transmitter; and causing the fuse to blow based on a determination that the Power Receiver is unsuccessful in communicating with the Power Transmitter or that the Power Transmitter is overpowering the Power Receiver.

Clause 17. The method of any one of clauses 14 to 16, further including: maintaining a closed position of a disconnect switch during the power state until the fuse is blown; and opening the disconnect switch after the switch is blown.

Clause 18. A method of a Power Receiver, including: monitoring a voltage or current measurement at a power reception circuit of the Power Receiver or at a load associated with the Power Receiver during a power state; sending a switch control signal to a fuse blowing switch when the voltage or current measurement exceeds a threshold, where the switch control signal causes the fuse blowing switch to short circuit a circuit that includes a replaceable safety fuse and a secondary coil of the Power Receiver.

Another innovative aspect of the subject matter described in this disclosure can be implemented as a computer-readable medium having stored therein instructions which, when executed by a processor, causes the processor to perform any one of the above-mentioned functionalities.

Another innovative aspect of the subject matter described in this disclosure can be implemented as a system having means for implementing any one of the above-mentioned functionalities.

Another innovative aspect of the subject matter described in this disclosure can be implemented as an apparatus having one or more processors configured to perform one or more operations from any one of the above-mentioned methods.

As used herein, a phrase referring to “at least one of” or “one or more of” a list of items refers to any combination of those items, including single members. For example, “at least one of: a. b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, for example, a combination of a DSP and a microprocessor, multiple microprocessors, one or more microprocessors in conjunction with a DSP core, or any other such configuration. In some implementations, particular processes, operations and methods may be performed by circuitry that is specific to a given function.

As described above, some aspects of the subject matter described in this specification can be implemented as software. For example, various functions of components disclosed herein, or various blocks or steps of a method, operation, process or algorithm disclosed herein can be implemented as one or more modules of one or more computer programs. Such computer programs can include non-transitory processor-executable or computer-executable instructions encoded on one or more tangible processor-readable or computer-readable storage media for execution by, or to control the operation of, a data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

Various modifications to the implementations described in this disclosure may be readily apparent to persons having ordinary skill in the art, and the generic principles defined herein may be applied to other implementations without departing from the scope of this disclosure. Thus, the claims are not intended to be limited to the implementations shown herein but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

1. A Power Receiver, comprising:
a secondary coil configured to receive wireless power from a primary coil of a Power Transmitter; and
a fuse configured to disconnect the secondary coil from a power reception circuit or a load associated with the Power Receiver.

2. The Power Receiver of claim 1, further comprising:
a capacitance element configured to match or cancel a portion of the impedance of the secondary coil.

3. The Power Receiver of claim 2, wherein the capacitance element is selectively enabled based on an overvoltage or overcurrent condition of the Power Receiver.

4. The Power Receiver of claim 1, further comprising:
a fuse blowing switch configured to short circuit the secondary coil and fuse.

5. The Power Receiver of claim 4, further comprising:
a controller configured to operate the fuse blowing switch, wherein the controller causes the fuse blowing switch to close based on a determination that a voltage or a current of the power reception circuit or the load is above a threshold.

6. The Power Receiver of claim 5, further comprising:
a sensor configured to detect the voltage or the current of the power reception circuit or the load during a power state,
wherein the controller is configured to:
monitor the voltage or the current during the power state, and
close the fuse blowing switch when the voltage or the current exceeds the threshold during the power state.

7. The Power Receiver of claim 4, wherein the fuse has a lower rating than the fuse blowing switch.

8. The Power Receiver of claim 4,
wherein the fuse is connected in series on a first leg of the secondary coil, and
wherein the fuse blowing switch is a shunt switch that connects a second leg of the secondary coil to the fuse such that the shunt switch closes a circuit that includes the secondary coil and the fuse.

9. The Power Receiver of claim 8, wherein the capacitance element is connected in series with the shunt switch.

10. The Power Receiver of claim 4, wherein the fuse blowing switch is a semiconductor switch or a mechanical relay.

11. The Power Receiver of claim 1, wherein the fuse is rated to block a maximum induced voltage in the secondary coil to prevent restrike across open terminals of the fuse.

12. The Power Receiver of claim 1, wherein the fuse has a current rating that is at least twenty percent (20%) higher than a nominal current of the Power Receiver.

13. The Power Receiver of claim 1, wherein the fuse is an end-user replaceable part of the Power Receiver.

14. A method of a Power Receiver (PRx) controller, comprising:
obtaining a voltage or current measurement at a power reception circuit of the Power Receiver or at a load associated with the Power Receiver; and
causing a fuse to blow when the voltage or current measurement exceeds a threshold.

15. The method of claim 14, wherein causing the fuse to blow includes:
sending a switch control signal to a fuse blowing switch to cause the fuse blowing switch to short circuit a circuit that includes the fuse and a secondary coil of the Power Receiver.

16. The method of claim 14, further comprising:
monitoring the voltage or current measurement during a power state;
attempting to control power based on the voltage or current measurement by communicating with a Power Transmitter; and
causing the fuse to blow based on a determination that the Power Receiver is unsuccessful in communicating with the Power Transmitter or that the Power Transmitter is overpowering the Power Receiver.

17. The method of claim 14, further comprising:
maintaining a closed position of a disconnect switch during the power state until the fuse is blown; and
opening the disconnect switch after the switch is blown.

18. A method of a Power Receiver, comprising:
monitoring a voltage or current measurement at a power reception circuit of the Power Receiver or at a load associated with the Power Receiver during a power state;
sending a switch control signal to a fuse blowing switch when the voltage or current measurement exceeds a threshold, wherein the switch control signal causes the fuse blowing switch to short circuit a circuit that includes a replaceable safety fuse and a secondary coil of the Power Receiver.
